(19) United States
(12) Patent Application Publication
(10) Pub. No.: US 2010/0264186 A1
(43) Pub. Date: Oct. 21, 2010

(54) POSITIONING MEMBER FOR BICYCLE RACKS

(76) Inventor: JACK C.T. SHEN, Wai Pu Hsiang (TW)

Correspondence Address: PHILLIP LIU, 6980, WHITEOAK DRIVE, RICHMOND, V7E4Z9, omitted

(21) Appl. No.: 12/426,212

(22) Filed: Apr. 17, 2009

(51) Int. Cl. B60R 9/10

(52) U.S. Cl. 224/501; 224/533

(57) ABSTRACT

A positioning member for bicycle racks includes a body made of resilient material and a passage defined through the body so that the bicycle rack extends through the passage. At least two support surfaces are located at outside of the body and have different widths. The at least two support surfaces are perpendicular to an axis of the passage. The support surfaces are selectively to support bicycles of different sizes.

### FIELD OF THE INVENTION

The present invention relates to a positioning member of a bicycle rack, and more particularly, to a positioning member with multiple support surfaces of different sizes so as to position bicycles of different sizes of frames.

### BACKGROUND OF THE INVENTION

A conventional bicycle rack is connected to rear end of a vehicle and multiple positioning members are connected to the bicycle rack so as to support and fasten the bicycles on the bicycle rack.

The conventional positioning members of the bicycle racks have fixed shape and size so that only some of the bicycle frames can be carried on the bicycle rack. However, there are so many different brands of bicycles available in the market and these bicycles have different shapes and sizes, if the positioning members that equipped with the bicycle rack do not fit the bicycle frame, the bicycle rack cannot be used to carry the bicycle. Besides, the positioning members are fixed to the bicycle rack so that the users have to purchase another bicycle rack with suitable positioning members for the bicycles to be carried.

The present invention intends to provide a positioning member for bicycle racks and multiple support surfaces are provided in the positioning member so as to support the bicycles of different sizes.

### SUMMARY OF THE INVENTION

The present invention relates to a positioning member for bicycle racks and comprises a body having a passage defined therethrough and at least two support surfaces are located at outside of the body. The at least two support surfaces are perpendicular to an axis of the passage and support bicycles of different sizes.

The primary object of the present invention is to provide a positioning member for bicycle racks and the positioning member include multiple support surfaces of different widths so as to support bicycles of different sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the flexible bands and the positioning member of the present invention;

FIG. 2 is a perspective view to show that the flexible bands are connected to the positioning member of the present invention;

FIG. 3 is a top view of the positioning member of the present invention;

FIG. 4 is a bottom view of the positioning member of the present invention;

FIG. 5 shows that a bicycle is support on a bicycle rack by the positioning member of the present invention, and

FIG. 6 shows that the flexible bands are able to fasten different parts of the bicycle.

### DETAILED DESCRIPTION OF THE PREFERRED EMBODIMENT

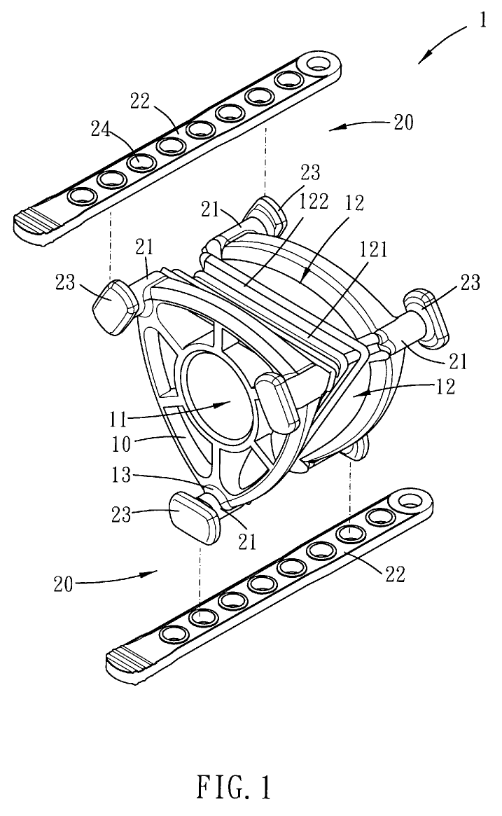

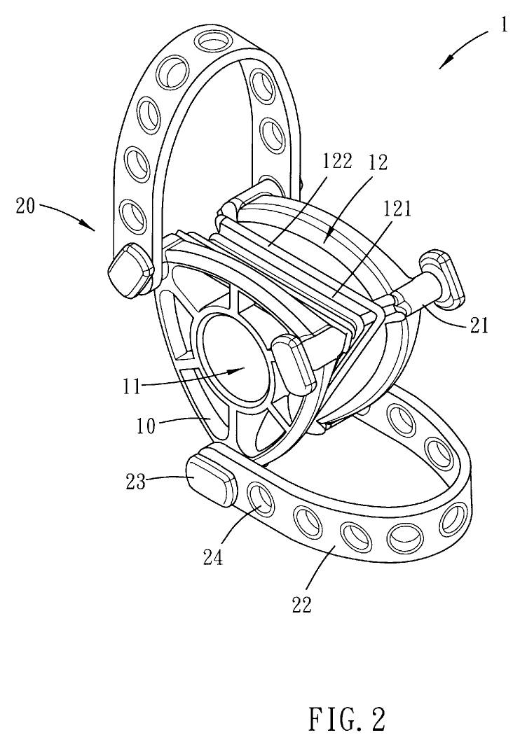

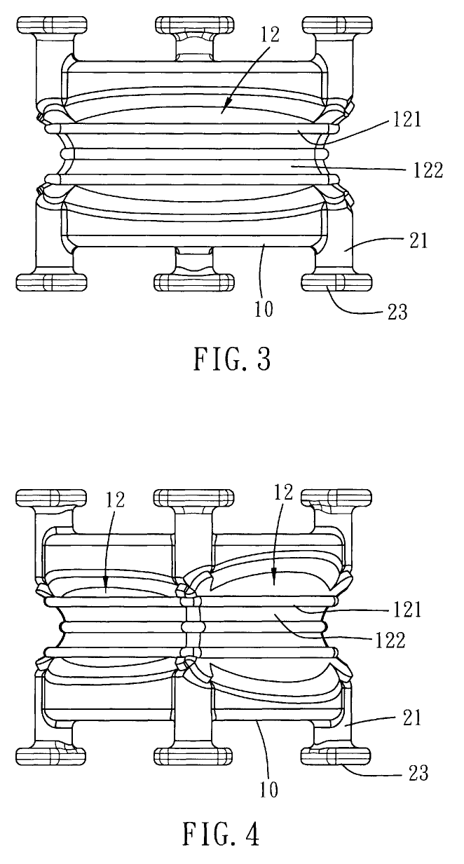

Referring to FIGS. 1 to 4, the positioning member 1 for a bicycle rack of the present invention comprises a polygonal body 10 having a passage 11 defined therethrough and at least two support surfaces 12 are located at outside of the body 10, in this embodiment, the body 10 is substantially a triangular body and includes three support surfaces 12. The support surfaces 12 are perpendicular to an axis of the passage 11. A corner portion 13 is located between the adjacent support surfaces 12 so that there are three corner portions 13. The support surfaces 12 have different widths so as to support bicycles 4 of different sizes. Each support surface 12 includes multiple lengthwise ribs 121 and grooves 122 are defined between the ribs 121. The ribs 121 are made of resilient material so that they can be deformed when supporting bicycles 4. The body 10 and the ribs 121 can be made by resilient material such as rubber or silicone rubber which prevents from scraping the bicycles 4 and are light in weight.

At least one fastening unit 20 is connected with the body 10, in this embodiment, there are two fastening units 20 and each include two protrusions 21 extending from two opposite sides of the body 10 and a flexible band 22. The two protrusions 21 extend from the corner portions 13 and each have an enlarged head 23. The flexible band 22 has multiple holes 24 and each hole 24 is smaller than a maximum diameter of the enlarged head 23 such that when the protrusions 21 extend through the holes 24, the enlarged head 23 passes through the one of the holes 24 to ensure that the flexible band 22 does not separate from the protrusion 21.

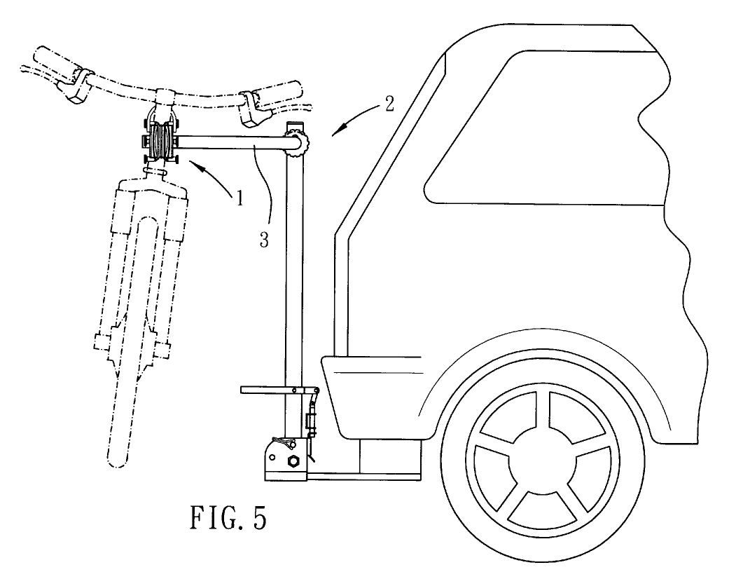

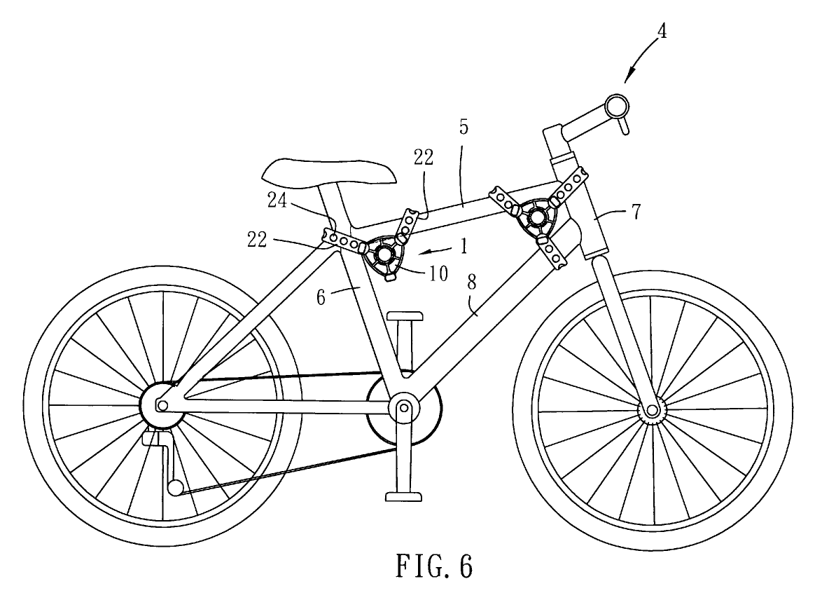

As shown in FIGS. 5 and 6, the bicycle rack is connected to the rear end of a vehicle and a support rod 3 of the bicycle rack extends through the passage 11 of the body 10. The top tube 5 of the bicycle 4 is supported by one of the support surfaces 12 and the flexible bands 22 have two ends connected to the two protrusions 21 on two opposite sides of the body 10 and secure the top tube 5 to the body 10.

It is noted that the flexible bands 22 can be pivotable relative to the protrusions 21 so that the flexible bands 22 can secure the top tube 5, the seat tube 6, the head tube 7 or the down tube 8 of the bicycle 4 as needed. The flexible bands 22 may have one end integrally fixed to the body 10 and the other end of the flexible bands 22 secure the bicycle 4 and connected to the protrusions 21.

The body 10 of the positioning member 1 includes multiple support surfaces 12 which have different widths such that the bicycles 4 of different sizes can be secured by the bodies 10 by choosing suitable support surfaces 12.

While we have shown and described the embodiment in accordance with the present invention, it should be clear to those skilled in the art that further embodiments may be made without departing from the scope of the present invention.

What is claimed is:

1. A positioning member for bicycle racks, comprising:
a body having a passage defined therethrough and at least two support surfaces located at outside of the body, the at least two support surfaces being perpendicular to an axis of the passage and adapted to support bicycles of different sizes.

2. The positioning member as claimed in claim 1, wherein at least one fastening unit is connected with the body and adapted to fasten the bicycles.

3. The positioning member as claimed in claim 2, wherein the at least one fastening unit includes two protrusions extending from the body and a flexible band, the two protrusions extend from two opposite sides of the body and each have an enlarged head, the flexible band has multiple holes and the protrusions extend through the holes, each hole is smaller than a maximum diameter of the enlarged head.

4. The positioning member as claimed in claim 3, wherein a corner portion is located between adjacent support surfaces and the two protrusions are located at the corner portions.

5. The positioning member as claimed in claim 3, wherein the flexible band is pivotable relative to the protrusion.

6. The positioning member as claimed in claim 1, wherein the at least two support surfaces have different widths.

7. The positioning member as claimed in claim 1, wherein the positioning member is made by resilient material.

8. The positioning member as claimed in claim 5, wherein the positioning member is made by resilient material.
